(19) United States
(12) Patent Application Publication
(10) Pub. No.: US 2016/0081881 A1
(43) Pub. Date: Mar. 24, 2016

(54) Time and Temperature Sensor Medication dispenser for hospitals and nursing homes/monthly personal time

(71) Applicant: Juliet Bragu Ababio, Wallkill, NY (US)

(72) Inventor: Juliet Bragu Ababio, Wallkill, NY (US)

(73) Assignee: Juliet Bragu Ababio, Wallkill, NY (US)

(21) Appl. No.: 14/257,735

(22) Filed: Apr. 21, 2014

Related U.S. Application Data
(60) Provisional application No. 61/945,076, filed on Feb. 26, 2014.

(51) Int. Cl. A61J 7/00; F21V 33/00; F21V 23/04; A61J 7/04

(52) U.S. Cl. CPC A61J 7/0076; A61J 7/0409; A61J 7/0454; A61J 7/0418; F21V 33/0068; F21V 23/0442; A61J 7/0069; A61J 2200/70; F21W 2131/20

(57) ABSTRACT

A medication dispenser is described. A plurality of drawers capable of storing medications is arranged in an array. For personal use, each drawer has an illuminatable number thereon representing a date in a month. For institutional use, each drawer has an associated adjacent illuminatable patient identification section. Illuminatable numbers in a row above the drawers correspond to hours in a day wherein a current time is displayed by illuminating one of the numbers. Rechargeable batteries maintain a memory capable of storing information about when each of a plurality of medications is to be taken. When the current time matches a time when one of the medications is to be taken, a number on the drawer corresponding to a current date or the particular patient identification section is illuminated. A sensor senses when a particular drawer is opened and saves in memory the current time and drawer identification.

### BRIEF DESCRIPTION OF THE DRAWINGS

In the accompanying drawings forming a material part of this description, there is shown:

FIG. 1 illustrates a perspective view of a first preferred embodiment of the present disclosure.

FIG. 2A illustrates a front view of a first preferred embodiment of the present disclosure.

FIG. 2B illustrates a top view of a first preferred embodiment of the present disclosure.

FIG. 2C illustrates a side view of a first preferred embodiment of the present disclosure.

FIG. 3 illustrates a perspective view of a second preferred embodiment of the present disclosure.

FIG. 4A illustrates a front view of a second preferred embodiment of the present disclosure.

FIG. 4B illustrates a top view of a second preferred embodiment of the present disclosure.

FIG. 4C illustrates a side view of a second preferred embodiment of the present disclosure.

FIG. 4D illustrates a close-up front view of a second preferred embodiment of the present disclosure.

### DETAILED DESCRIPTION

An error free medication dispenser for assisted-living and personal use is disclosed. The medication dispenser keeps a record of all medications and injectables taken by a patient. It records the time and day the medications are taken. Missing of medications is prevented by notification of when a medication is due to be taken. A temperature sensor and regulator in the dispenser helps to ensure the medications' stability. The dispenser is affordable, durable, and energy-efficient with rechargeable batteries. Since the dispenser runs on batteries and is of a compact size, it is portable enough to bring to a patient's doctor's office or on vacation.

Especially when used in a hospital or nursing home setting, the dispenser prevents waste of medication, contamination by mixing liquid and nonliquid medications. There is easy access to replace unused medications into storage. A removable tray can fit into a drawer in the dispenser that will prevent needle sticks and will allow easy transfer of the medication for a patient transfer or discharge. A safety lock is included for accountability.

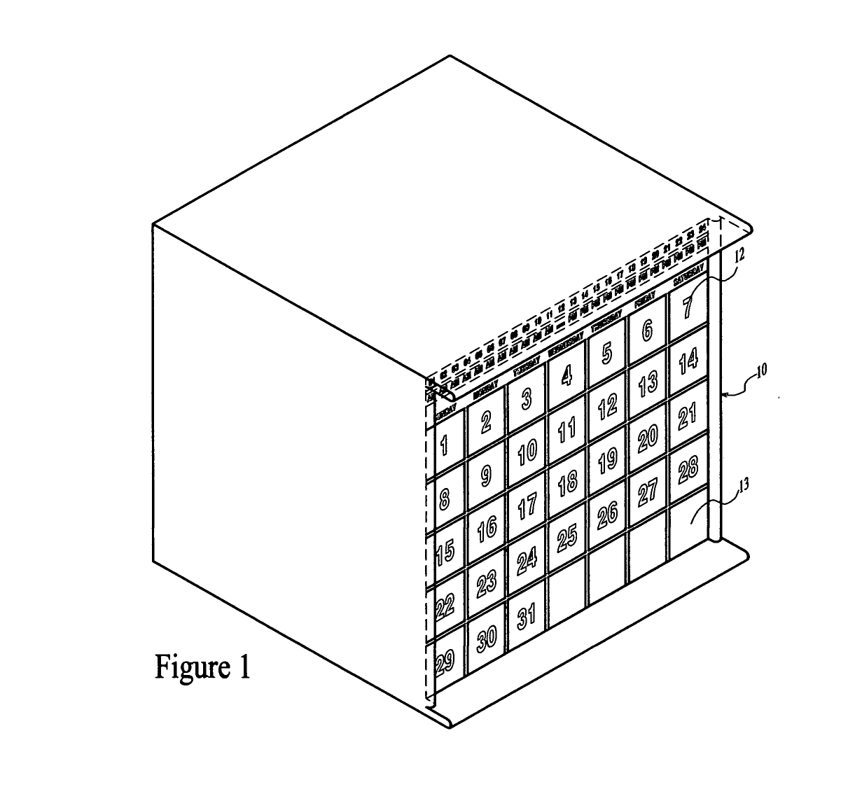

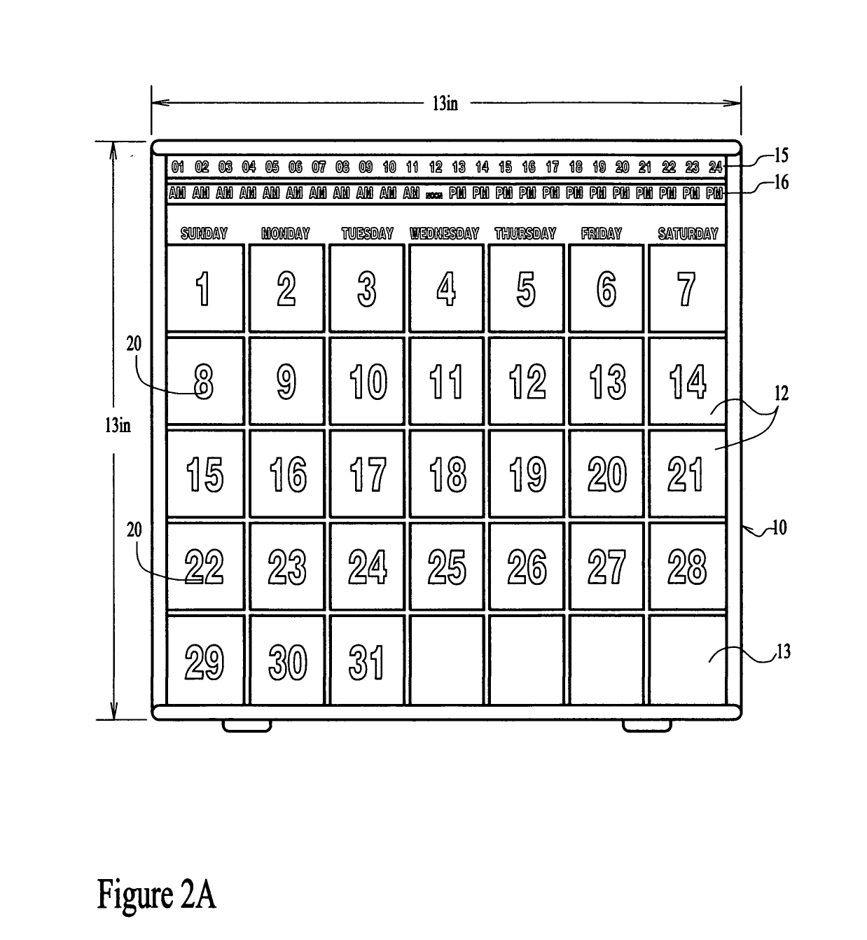

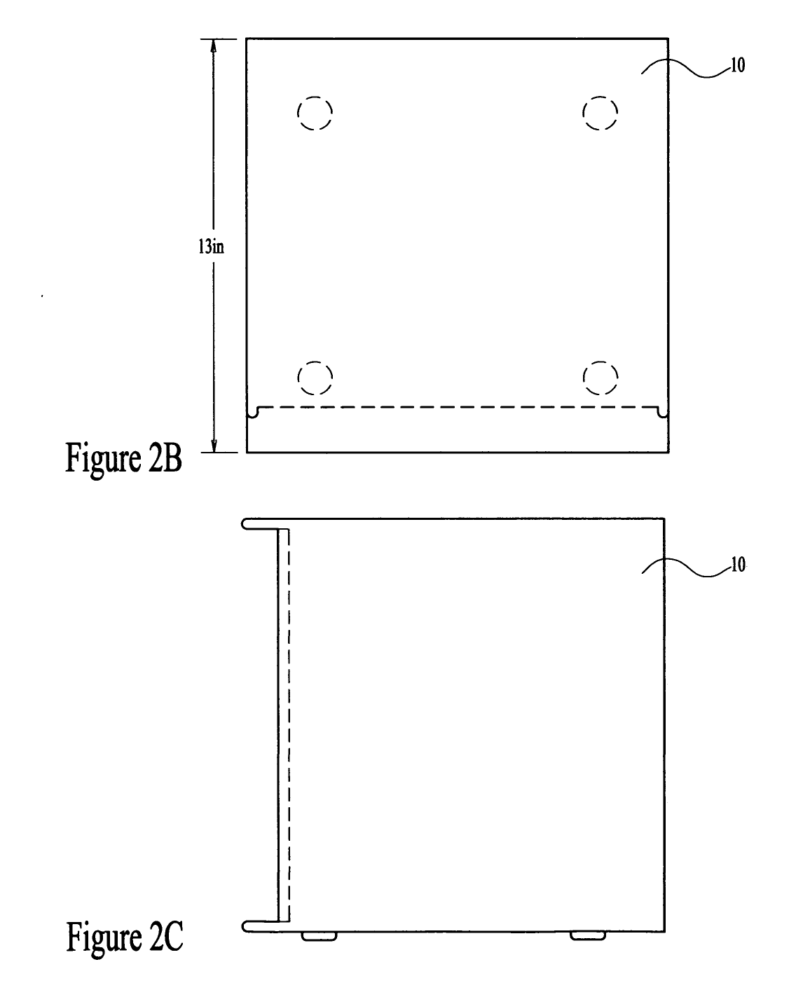

Referring now to the drawing figures, the medication dispenser of the present disclosure will be described in detail. A first preferred embodiment of the disclosure is a medication dispenser for personal use, as shown in FIG. 1. The medication dispenser 10 is a compact, portable size. For example, as shown in FIGS. 2A and 2B, the dispenser could be in the shape of a 13-inch cube.

As shown in FIG. 1, the medication dispenser is in the form of a small cabinet containing an array of drawers. Each drawer 12 is inscribed with a number from 1 to 31, arranged in rows of seven. Drawers 13 have no numbers on them, but are extra drawers to fill out the bottom row of seven. Along the top of the cabinet 10 are numbers 1 through 24 in row 15 and indicators for AM, noon, and PM in row 16. These numbers will indicate the time of day in either a 12-hour clock mode using numbers 1-12 in row 15 and AM/PM in row 16 or 24-hour clock mode using all the numbers in row 15. FIG. 2A shows a front view of the cabinet, FIGS. 2B shows a top view, and FIG. 2C shows a side view.

In preparing the medication dispenser cabinet for use, a patient will put all needed medications in the drawers 12 corresponding to each date of the month. Any extra medication that is not to be taken on a daily schedule can be put into the extra drawers 13. The patient will input information about each medication into the medication dispenser cabinet's memory, including setting indicators of when the medication is to be taken at particular times on particular days. Rechargeable batteries maintain this memory.

The current time of day is shown at the top of the cabinet by illumination of the numbers 15 corresponding to the current time, using AM/PM in row 16 if 12-hour clock time has been selected. When it is time for a particular medication to be taken, the numbers 20 on the drawer corresponding to the current date are illuminated. When a patient opens the drawer to take the medication, a sensor in the cabinet recognizes that the drawer has been opened and records the date and time. A temperature sensor in the cabinet ensures the medications' stability.

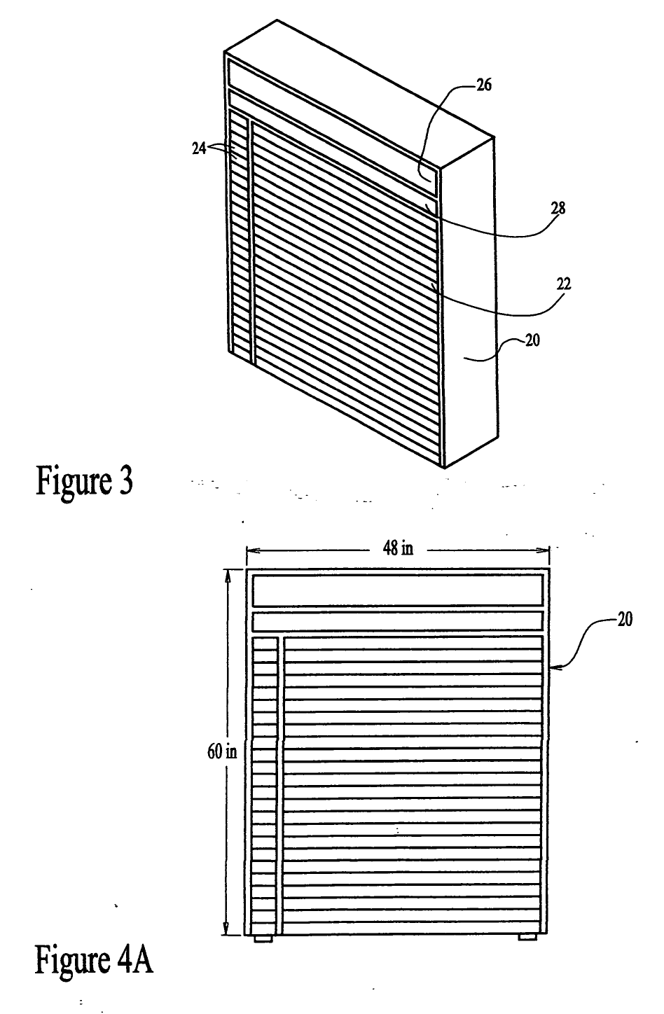

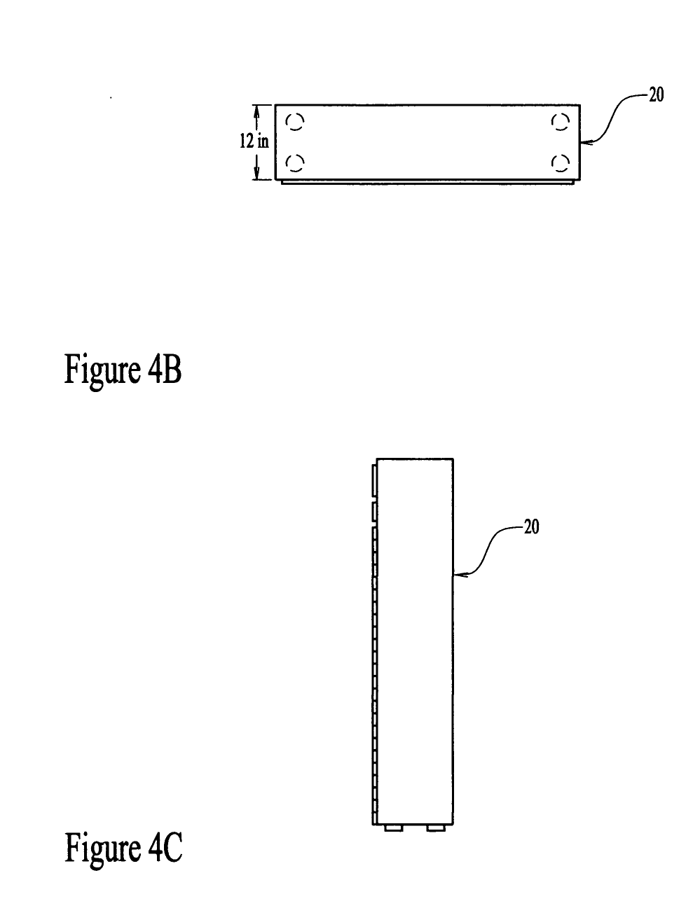

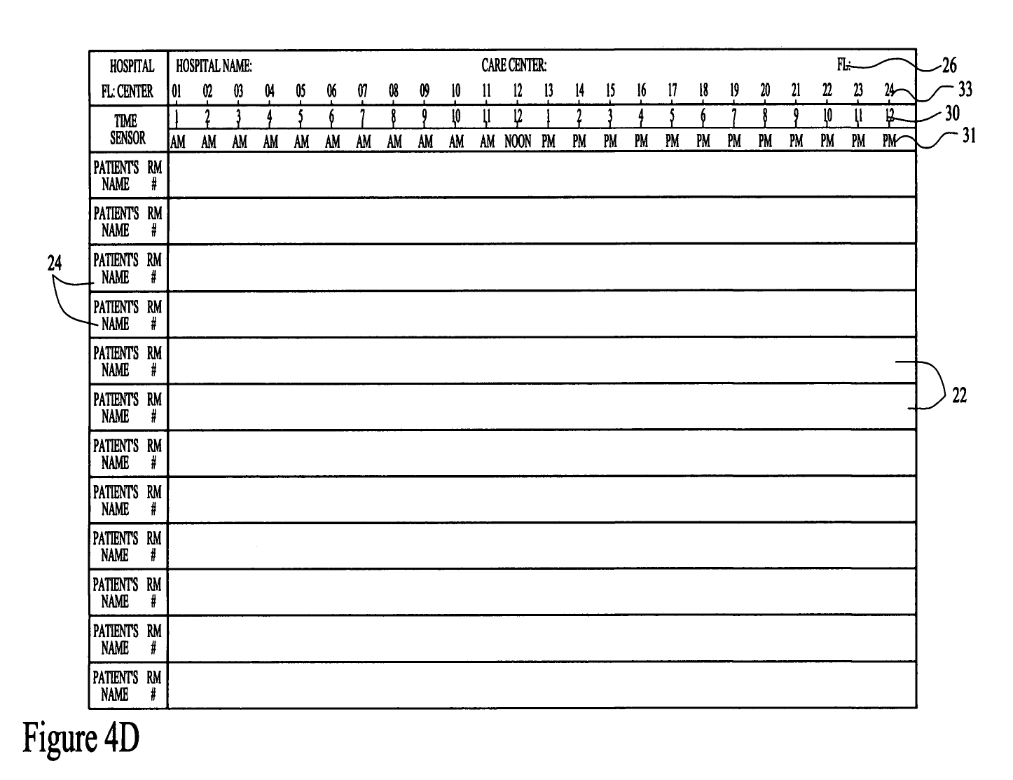

A second preferred embodiment of the disclosure is a medication dispenser for assisted living use, as shown in FIG. 3. The medication dispenser 20 is a portable size. For example, as shown in FIGS. 4A and 4B, the dispenser could be 60 inches tall, 48 inches wide, and 12 inches deep.

As shown in FIG. 3 and in close-up in FIG. 4D, the medication dispenser is in the form of a cabinet containing a vertical column of drawers. Each drawer 22 is associated with an adjacent patient identification section 24. Information such as the patient's name and room number can be entered into the patient identification section 24, as shown in FIG. 4D. Along the top of the cabinet 20 is a section 26 where information is entered about the hospital or assisted living facility using the cabinet, as shown in FIG. 4D. A second top section 28 below section 26 is used for time sensor information. As shown in FIG. 4D, numbers 1 through 24 in row 33 are used for 24-hour clock mode. Numbers 1-12 and 1-12 in row 30 and indicators for AM, noon, and PM in row 31 will indicate the time of day in 12-hour clock mode. FIG. 4A shows a front view of the cabinet, FIGS. 4B shows a top view, and FIG. 4C shows a side view.

In preparing the medication dispenser cabinet 20 for use, a caregiver will put all needed medications and/or IV medications in the drawers 22 needed for each patient for the entire day. The caregiver will input information about each medication into the medication dispenser cabinet's memory, including setting indicators of when the medications are to be taken at particular times of the day. Rechargeable batteries maintain this memory.

The current time of day is shown at the top of the cabinet by illumination of the numbers 33 or 30 corresponding to the current time, using AM/PM in row 31 if 12-hour clock time has been selected. When it is time for a particular patient to take a medication, the patient identification section 24 is illuminated for that patient. When the caregiver opens the drawer 22 associated with the patient identified to administer the medication, a sensor in the cabinet recognizes that the drawer has been opened and records the date and time. A temperature sensor in the cabinet ensures the medications' stability.

What is claimed is:

1. A medication dispenser for personal use comprising:
a plurality of drawers arranged in a two-dimensional array, each drawer having an illuminatable number thereon representing a date in a month, wherein each drawer is capable of storing medication to be taken on a particular date corresponding to said number on said drawer;
illuminatable numbers in a row above said array of drawers wherein said numbers correspond to hours in a day wherein a current time is displayed by illuminating one of said numbers;
rechargeable batteries for maintaining a memory capable of storing information about when each of a plurality of medications is to be taken; and
a sensor capable of sensing when a particular drawer is opened wherein when said current time matches a time when one of said medications is to be taken, a number on said drawer corresponding to a current date is illuminated, and wherein when said drawer is opened, said sensor causes said drawer number and said current time to be saved in said memory, indicating that a medication was taken at said current date and said current time.

2. A medication dispenser for institutional use comprising:
a plurality of drawers arranged in a vertical array, each drawer having an associated adjacent illuminatable patient identification section, wherein each drawer is capable of storing medication to be taken by a patient identified by said patient identification section;
illuminatable numbers in a row above said array of drawers wherein said numbers correspond to hours in a day wherein a current time is displayed by illuminating one of said numbers;
rechargeable batteries for maintaining a memory capable of storing information about when each of a plurality of medications is to be taken by each of a plurality of patients; and
a sensor capable of sensing when a particular drawer is opened wherein when said current time matches a time when one of said medications is to be taken by a patient, said patient identification section associated with said patient is illuminated, and wherein when said drawer adjacent to said illuminated patient identification section is opened, said sensor causes information in said patient identification section adjacent to said drawer and said current time to be saved in said memory, indicating that a medication was taken by said patient at said current time.
